(19) United States
(12) Patent Application Publication
(10) Pub. No.: US 2007/0201554 A1
(43) Pub. Date: Aug. 30, 2007

(54) Video transcoding method and apparatus

(75) Inventor: Kue-hwan Sihn, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/704,311

(22) Filed: Feb. 9, 2007

(30) Foreign Application Priority Data
Feb. 24, 2006 (KR) 10-2006-0018295
Jan. 3, 2007 (KR) 10-2007-0000791

(51) Int. Cl. H04N 7/12; H04N 11/04

(52) U.S. Cl. 375/240.12; 375/240.18

(57) ABSTRACT

Provided are a method and apparatus for selecting an appropriate reference frame at high speed from a plurality of reference frames when transcoding an input video stream into a different format having a different group of pictures (GOP) structure from that of the input video stream. A transcoder, which transcodes an input video stream into an output video stream, includes a reconstruction unit which reconstructs transform coefficients and a video frame from the input video stream; a selection unit which selects one of a first frame, which is referred to by the video frame, and a second frame, which is located at a different position from the first frame, based on sizes of the transform coefficients; and an encoding unit which encodes the reconstructed video frame by referring to the selected frame.

### CROSS-REFERENCE TO RELATED APPLICATION

This application claims priority from Korean Patent Application Nos. 10-2006-0018295 and 10-2007-0000791 filed on Feb. 24, 2006, and Jan. 3, 2007, respectively, in the Korean Intellectual Property Office, the disclosures of which are incorporated herein in their entireties by reference.

### BACKGROUND OF THE INVENTION

1. Field of the Invention

The present invention relates to a video transcoding method and apparatus, and more particularly, to a method of selecting an appropriate reference frame at high speed from a plurality of reference frames when transcoding an input video stream into a different format having a different group of pictures (GOP) structure from that of the input video stream.

2. Description of the Related Art

The development of information and communication technology (ICT) including the Internet has increased video communication as well as text and voice communication. As conventional text-oriented communication fails to satisfy various needs of users, multimedia services, which can provide various types of information such as text, images and music, have been increased. Due to its large size, multimedia data requires a large-capacity storage medium. In addition, a wide bandwidth is required to transmit the multimedia data. Therefore, a compression coding method is a requisite for transmitting the multimedia data including text, images, and audio.

A basic principle of data compression lies in removing data redundancy. That is, data can be compressed by removing spatial redundancy which has to do with repetition of the same color or object in an image, temporal redundancy which occurs when there is little change between adjacent frames in a moving-image frame or when the same sound repeats in audio, or psychological visual redundancy which takes into consideration insensitivity of human eyesight and perception to high frequency. In a related art video coding method, temporal filtering based on motion compensation is used to remove temporal redundancy of video data, and a spatial transform is used to remove spatial redundancy of the video data.

The result of removing video data redundancy is lossy coded through a predetermined quantization process. Then, the quantization result is finally losslessly coded through an entropy coding process.

Encoded video data may be transmitted to a final terminal and decoded by the final terminal. However, the encoded video data may also be transcoded in consideration of network condition or the performance of the final terminal before being transmitted to the final terminal. For example, if the encoded video data is not appropriate to be transmitted through a current network, a transmission server modifies the signal-to-noise ratio (SNR), frame rate, resolution or coding method (codec) of the video data. This process is called “transcoding.”

A related art method of transcoding Motion Picture Experts Group (MPEG)-2 coded video data using an H.264 algorithm may be classified into a conversion method in a frequency domain and a conversion method in a pixel domain. Generally, the conversion method in the frequency domain is used in a transcoding process when there is a high similarity between an input format and an output format, and the conversion method in the pixel domain is used when there is a low similarity between them. In particular, the conversion method in the pixel domain reuses an existing motion vector estimated during an encoding process.

However, if the structure of a GOP or a motion vector referencing method is changed after the transcoding process, it is difficult to use the existing motion vector. For this reason, if a motion vector is recalculated based on images which were reconstructed in the transcoding process, a lot of time and resources may be consumed. If a frame at a distance is referred to in order to avoid such recalculation, a greater residual may be generated than when an immediately previous frame is referred to, thereby increasing bit rate and deteriorating image quality.

That is, when video streams having different GOP structures are transcoded, it is very difficult to determine which frame to use as a reference frame in order to obtain an appropriate trade-off among calculation complexity, image quality, and bit rate.

### SUMMARY OF THE INVENTION

The present invention provides a method and apparatus for selecting an appropriate reference frame in consideration of transcoding speed and image quality when transcoding an input video stream into an output video stream having a different GOP structure (referencing method) from that of the input video stream.

According to an aspect of the present invention, there is provided a transcoder which transcodes an input video stream into an output video stream. The transcoder includes a reconstruction unit which reconstructs transform coefficients and a video frame from the input video stream; a selection unit which selects one of a first frame, which is referred to by the video frame, and a second frame, which is located at a different position from the first frame, based on sizes of the transform coefficients; and an encoding unit which encodes the reconstructed video frame by referring to the selected frame.

According to another aspect of the present invention, there is provided a method of transcoding an input video stream into an output video stream. The method includes reconstructing transform coefficients and a video frame from the input video stream; selecting one of a first frame, which is referred to by the video frame, and a second frame, which is located at a different position from the first frame, based on sizes of the transform coefficients; and encoding the reconstructed video frame by referring to the selected frame.

### BRIEF DESCRIPTION OF THE DRAWINGS

The above and other aspects of the present invention will become more apparent by describing in detail exemplary embodiments thereof with reference to the attached drawings, in which:

FIG. 1A illustrates a GOP structure of a MPEG-2 video main profile;

FIG. 1B illustrates a GOP structure of an H.264 baseline profile;

FIGS. 2A and 2B illustrate the concept of multiple referencing supported by H.264;

FIGS. 3A and 3B are diagrams for explaining a method of selecting a reference frame in a transcoding process;

FIG. 4 is a block diagram of a transcoder according to an exemplary embodiment of the present invention;

FIG. 5 is a block diagram of a reconstruction unit included in the transcoder of FIG. 4; and

FIG. 6 is a block diagram of an encoding unit included in the transcoder of FIG. 4.

### DETAILED DESCRIPTION OF EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the exemplary embodiments set forth herein; rather, these exemplary embodiments are provided so that this disclosure will be thorough and complete, and will fully convey the concept of the invention to those skilled in the art.

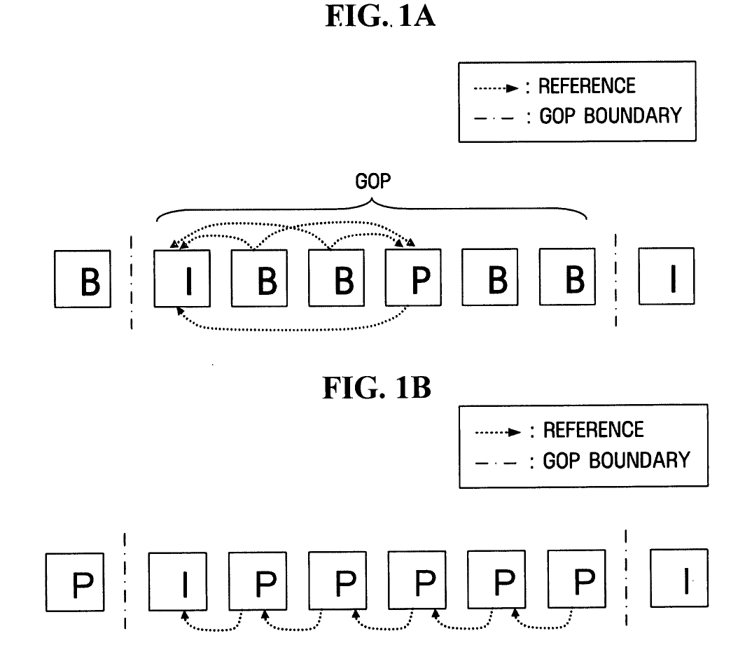

FIG. 1A illustrates a GOP structure of a MPEG-2 video main profile. FIG. 1B illustrates a GOP structure of an H.264 baseline profile. Referring to FIGS. 1A and 1B, a bi-directional (B) frame can refer to an intra (I) frame or a predictive (P) frame placed before or after the B frame, but cannot refer to another B frame. However, the P frame can refer to an I frame or another P frame. Such referencing is generally performed within one GOP structure.

Meanwhile, the H.264 baseline profile has a GOP structure in which a frame refers to its immediately previous frame as illustrated in FIG. 1B. Generally, the H.264 baseline profile has a GOP structure in which multiple frames as well as a single frame can be referred to within a single GOP.

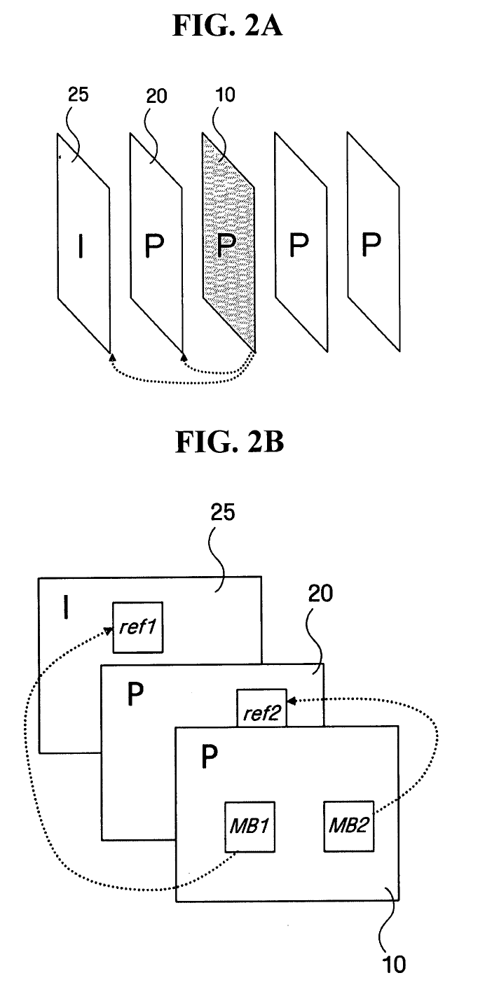

FIGS. 2A and 2B illustrate the concept of multiple referencing supported by H.264. Referring to FIG. 2A, a current P frame 10 can simultaneously refer to a plurality of frames 20 and 25. Such multiple referencing can be carried out, since the estimation of motion vectors and the generation of a residual of a current frame are performed in units of macroblocks, not frames.

FIG. 2B illustrates a case where different macroblocks MB1 and MB2 in the current P frame 10 respectively refer to different regions ref1 and ref2 in the different frames 20 and 25. In this way, H.264 offers diversity and adaptability of video coding, since an appropriate reference frame is selected for each macroblock.

In order to transcode an input video illustrated in FIG. 1A into an output video having a different GOP structure from that of the input video and illustrated in FIG. 2B, a transcoder has to recalculate a motion vector of the input video. However, if the motion vector is recalculated so that the output video can refer to an immediately previous frame, a lot of calculation time is consumed. On the other hand, if a frame located at a large distance from the output video is referred to using a referencing method of the input video in order to avoid such recalculation, a greater residual may be generated than when an immediately previous frame is referred to, thereby deteriorating image quality or increasing bit rate. Therefore, it is required to find an appropriate trade-off between the amount of calculation and image quality (or bit rate) in a transcoding process.

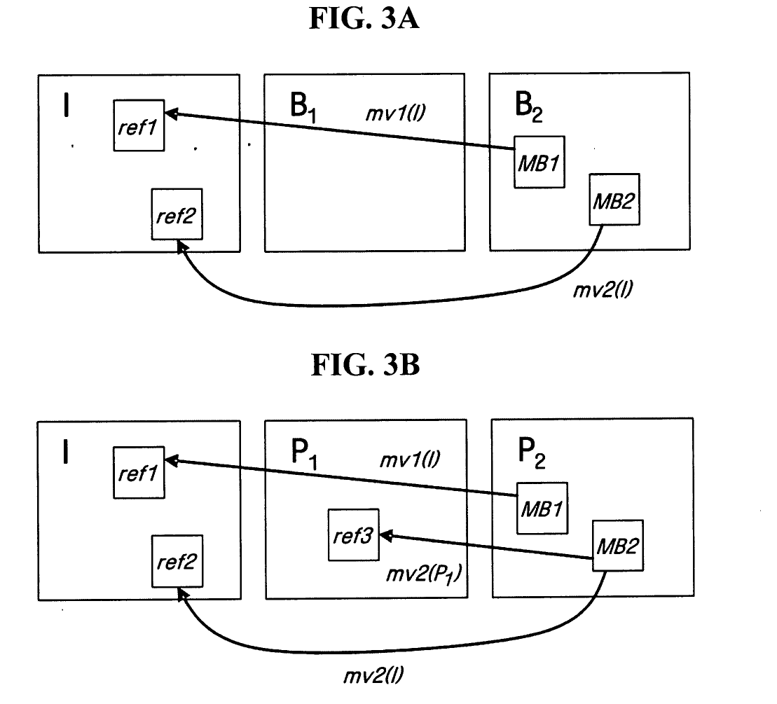

FIGS. 3A and 3B are diagrams for explaining a method of selecting a reference frame in a transcoding process. Specifically, FIG. 3A illustrates the structure of an input video before the transcoding process. FIG. 3B illustrates the structure of an output video after the transcoding process. Referring to FIG. 3A, a frame currently being processed is B₂, and a motion vector indicates an I frame. In an MPEG-2 structure, all forward reference vectors of the B₂ frame indicate the I frame. On the other hand, in an H.264 structure as illustrated in FIG. 3B, forward motion vectors mv1 and mv2 of macroblocks MB1 and MB2 may indicate an I frame or a Pₗ frame. If the motion vector mv2 (I) indicating the I frame does not generate a significantly greater residual than the motion vector mv2 (Pₗ) indicating the Pₗ frame, it may be advantageous to select the motion vector mv2 (I) in order to increase calculation speed. If the motion vector mv2 (I) generates a significantly greater residual than the motion vector mv2 (Pₗ), it may be advantageous to select the motion vector mv2 (Pₗ).

According to an exemplary embodiment of the present invention, there is provided a method of selecting an appropriate reference frame for a transcoding process in which a GOP structure is changed. That is, there is provided a method of determining a reference frame of an input video or an immediately previous frame as a reference frame for a transcoding process when the specification of an output video supports multiple referencing as in H.264. If the reference frame of the input video is used, an existing motion vector of the input video can be reused, thereby making high-speed conversion possible. If a new reference frame is used, a lot of calculation is required, but superior image quality can be achieved. In this regard, optimal transcoding may be performed by finding an appropriate trade-off between transcoding speed and image quality.

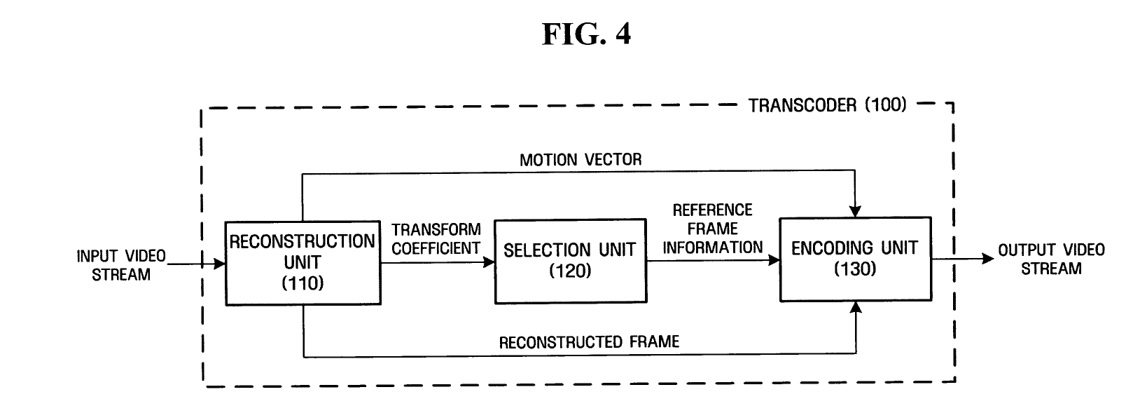

FIG. 4 is a block diagram of a transcoder according to an exemplary embodiment of the present invention. Referring to FIG. 4, the transcoder 100 converts an input video stream into an output video stream. To this end, the transcoder 100 may include a reconstruction unit 110, a selection unit 120, and an encoding unit 130.

The reconstruction unit 110 reconstructs transform coefficients and a video frame from the input video stream. The selection unit 120 selects one of a first frame, which is referred to by the video frame, and a second frame, which is located at a different position from the first frame, based on the sizes of the transform coefficients. The encoding unit 130 encodes the reconstructed video frame by referring to the selected frame.

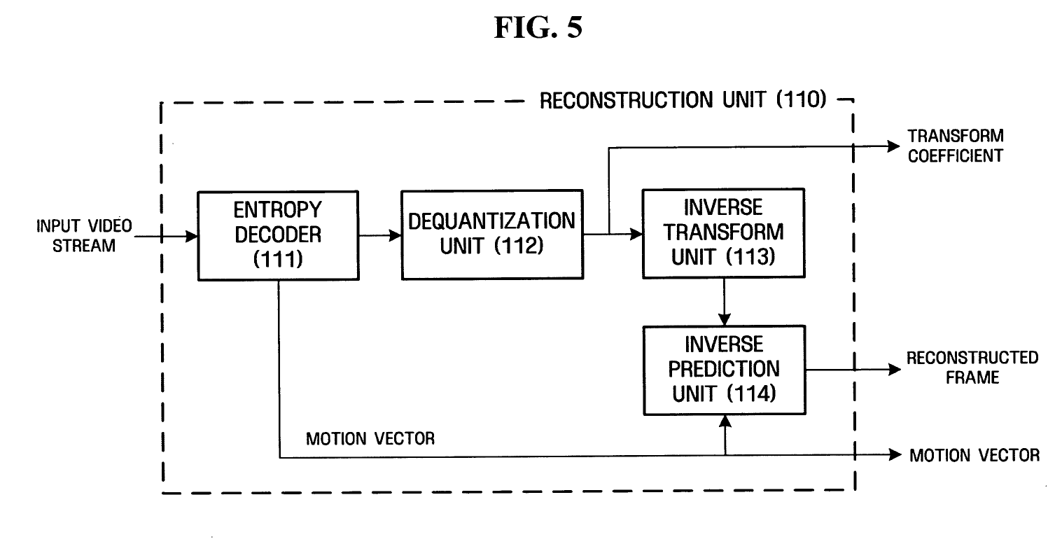

FIG. 5 is a block diagram of the reconstruction unit 110 illustrated in FIG. 4. Referring to FIG. 5, the reconstruction unit 110 may include an entropy decoder 111, a dequantization unit 112, an inverse transform unit 113, and an inverse prediction unit 114.

The entropy decoder 111 losslessly decodes an input video stream using an algorithm, such as variable length decoding (VLD) or arithmetic decoding, and reconstructs a quantization coefficient and a motion vector.

The dequantization unit 112 dequantizes the reconstructed quantization coefficient. This dequantization process is a reverse process of a quantization process performed by a video encoder. After the dequantization process, a transform coefficient can be obtained. The transform coefficient is provided to the selection unit 120.

The inverse transform unit 113 inversely transforms the transform coefficient using an inverse spatial transform method, such as an inverse discrete cosine transform (IDCT) or an inverse wavelet transform.

The inverse prediction unit 114 performs motion compensation on a reference frame for a current frame using the motion vector reconstructed by the entropy decoder 111, and generates a predictive frame. The generated predictive frame is added to the result of the inverse transform performed by the inverse transform unit 113. Consequently, a reconstructed frame is generated.

Referring back to FIG. 4, the selection unit 120 determines whether to use the first frame, which was used as a reference frame in the input video stream, or use the second frame based on the transform coefficient provided by the reconstruction unit 110. To this end, the selection unit 120 calculates a threshold value based on the transform coefficient, and uses the calculated threshold value as a determination standard.

In this exemplary embodiment of the present invention, a method of using a fixed threshold value within a frame and a method of using a variable threshold value within a frame, in which a threshold value adaptively varies so that the threshold value can be applied in real time, will be used as examples.

Method of Using a Fixed Threshold Value

In this exemplary embodiment, a threshold value TH_{g} is fixed in a single frame. The threshold value TH_{g} may be determined in various ways. For example, the threshold value TH_{g} may be given by Equation (1).

$${TH}_{g} = \frac{{V}_{ctl}}{N} {\sum }_{m = 0}^{N - 1} {\sum }_{i , j} \vert {C}_{m} ( i , j ) \vert \qquad ( 1 )$$

where N indicates the number of blocks in a frame, and Cₘ(i,j) indicates a transform coefficient at the position of coordinates (i,j) in an mth block. In addition, V_{ctl} indicates a control parameter (default value=1.0) which can control the size of the threshold value TH_{g}. Each block may have the size of a DCT block, which is a unit of a DCT transform, or the size of a macroblock, which is a unit of motion estimation.

If an index of a current block is k, a standard for selecting a reference frame, is as defined by Equation 2.

$$\begin{matrix}\begin{matrix} If ( \sum \vert {C}_{k} ( i , j ) \vert < {TH}_{g} ) , \\ {Ref}_{orig} is selected as a reference frame , \\ or else {Ref}_{0} is selected as a reference frame . \end{matrix}\end{matrix} \qquad ( 2 )$$

where Σ|Cₖ(i,j)| denotes a sum of absolute values of transform coefficients included in the current block, Ref_{orig} denotes a first frame used as the reference frame of the current block in an input video stream, and Ref₀ denotes a second frame located at a different position from the first frame. Preferably, the second frame may be an immediately previous frame of a frame (current frame) to which the current block belongs. According to Equation (2), a frame closest to the current frame is selected as the reference frame of a block having greater energy than average. Therefore, a block having less energy than average uses a motion vector in the input video stream, whereas the block having greater energy than average uses a new motion vector calculated using a frame relatively closer to the current frame as the reference frame. In this way, an appropriate trade-off between image quality and transcoding speed can be found. A method of calculating a threshold value by considering unprocessed blocks as well as processed blocks as in Equation (1) may require a rather large amount of calculation. Therefore, if an index of the current block to be processed is k, the threshold value TH_{g} may also be calculated by considering currently processed blocks only as in Equation (3).

$${TH}_{g} = \frac{{V}_{ctl}}{k} {\sum }_{m = 0}^{k} {\sum }_{i , j} \vert {C}_{m} ( i , j ) \vert \qquad ( 3 )$$

Blocks in units of which the selection unit 120 selects the reference frame may have different sizes from those of macroblocks to which motion vectors are actually allocated. In this case, it may be required to integrate or disintegrate the motion vectors.

Method of Using a Variable Threshold Value In order to apply a transcoder in real time, it is very important whether the transcoder can process frames before a time limit. In real-time transcoding, a threshold value needs to be variably adjusted using a currently available calculation time as a factor. That is, a variable threshold value TH, may be calculated by multiplying a fixed threshold value TH_{g} by a variable coefficient RTfactor as in Equation (4).

THₗ=TH_{g}*RTfactor (4)

According to Equation (4), when a time limit for processing a current frame is likely to be exceeded, the threshold value THₗ may be increased, thereby increasing transcoding speed. If sufficient time is left before the time limit, the threshold value THₗ may be reduced, thereby enhancing image quality. The variable coefficient RTfactor may be determined in various ways. If an index of a block currently being processed and the remaining time before the time limit are factors to be considered, the variable coefficient RTfactor may be determined using Equation (5).

$$RTfactor = \frac{( N - k ) / N}{( {T}_{due} - {T}_{cur} ) * framerate} \qquad ( 5 )$$

where k indicates an index number (0≦k<N) of the currently processed block, and N indicates a total number of blocks included in a frame. In addition, T_{due} indicates a time by which the conversion of the current frame must be completed, T_{cur} indicates a current time, and framerate indicates the number of frames per second during image reproduction. Framerate is a constant but is multiplied by (T_{due}−T_{cur}) in order to normalize (T_{due}−T_{cur}). Therefore, each of a numerator and a denominator in Equation (5) has a value between 0 and 1. According to Equation (5), the greater the number of blocks remaining to be processed in a current frame, the greater the variable coefficient RTfactor. Therefore, transcoding speed can be increased. In addition, the more time left before a time limit, the smaller the variable coefficient RTfactor. Therefore, transcoding speed can be decreased, which results in better image quality.

Similarly, the variable coefficient RTfactor may also be defined by Equation (6).

RTfactor=1+((N−k)|N−(T_{due}−T_{cur})*framerate) (6)

The selection unit 120 compares the fixed threshold value or the variable threshold value described above with the sum of absolute values of transform coefficients included in the current block and determines whether to use a motion vector and a reference frame (the first frame) of the input video stream or to calculate a motion vector by referring to a new frame (the second frame). Such a decision is made for each block and is provided to the encoding unit 130 as reference frame information.

A method of approximating a reverse motion vector to a forward motion vector is well known. Therefore, when the forward motion vector cannot be obtained, the reverse motion vector may be approximated to the forward motion vector, and the forward motion vector may be used instead of an existing motion vector and a reference frame. For example, if a macroblock of a B frame refers to a block of a P frame placed after the B frame, one of macroblocks of the P frame, which overlap the block, may be selected. That is, a macroblock overlapping a largest proportion of the block may be selected. Then, a motion vector of the selected macroblock for an I frame that precedes the P frame may be obtained. In this case, the motion vector for the I frame, which can be used by the B frame, may be a sum of a motion vector for the block of the P frame and the motion vector (for the I frame) of the largest overlapping macroblock of the P frame.

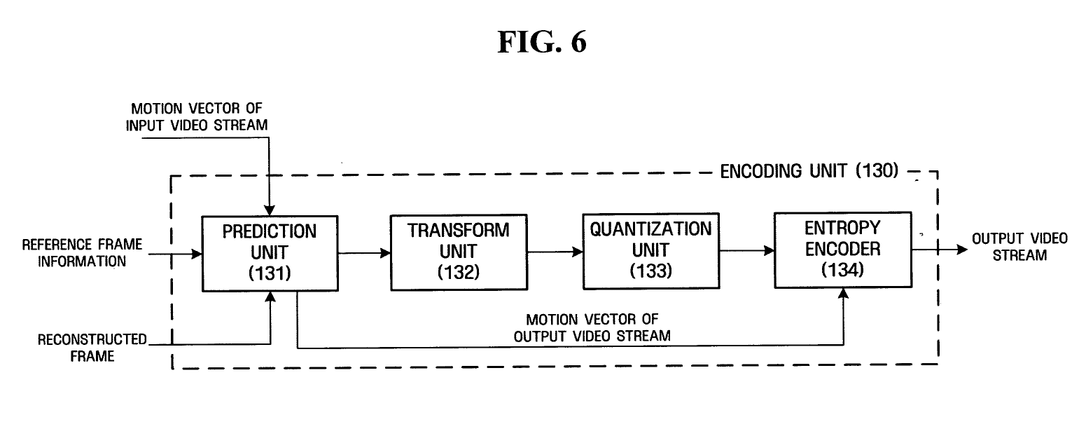

FIG. 6 is a block diagram of the encoding unit 130 illustrated in FIG. 4. Referring to FIG. 6, the encoding unit 130 may include a prediction unit 131, a transform unit 132, a quantization unit 133, and an entropy encoder 134.

The prediction unit 131 obtains a motion vector for each block of a current frame using the reference frame information and using one of the first and the second frames as a reference frame. The first frame denotes a frame used as a reference frame of the current frame among frames reconstructed by the reconstruction unit 110. The second frame denotes a frame located at a different temporal position from the first frame.

When a block of the current frame uses the first frame as the reference frame, the prediction unit 131 allocates an existing motion vector of the input video stream to the block. If the block uses the second frame as the reference frame, the prediction unit 131 estimates a motion vector by referring to the second frame and allocates the estimated motion vector to the block.

In addition, the prediction unit 131 performs motion compensation on a corresponding reference frame (the first or the second frame) using motion vectors allocated to the blocks of the current frame and thus generates a predictive frame. Then, the prediction unit 131 subtracts the predictive frame from the current frame and generates a residual.

The transform unit 132 performs a spatial transform on the generated residual using a spatial transform method such as a DCT or a wavelet transform. After the spatial transform, a transform coefficient is obtained. When the DCT is used as the spatial transform method, a DCT coefficient is obtained. When the wavelet transform is used as the spatial transform method, a wavelet coefficient is obtained.

The quantization unit 133 quantizes the transform coefficient obtained by the transform unit 132, and generates a quantization coefficient. Quantization is a process of dividing a transform coefficient represented by a real number into sections represented by discrete values. A quantization method includes scalar quantization and vector quantization. In particular, the scalar quantization, which is relatively simple, is a process of dividing a transform coefficient by a corresponding value in a quantization table and rounding off the division result to the nearest integer.

The entropy encoder 134 losslessly encodes the quantization coefficient and the motion vector provided by the prediction unit 131 and generates an output video stream. A lossless encoding method used here may be arithmetic coding or variable length coding (VLC).

Each component described above with reference to FIGS. 4 through 6 may be implemented as a software component, such as a task, a class, a subroutine, a process, an object, an execution thread or a program performed in a predetermined region of a memory, or a hardware component, such as a Field Programmable Gate Array (FPGA) or Application Specific Integrated Circuit (ASIC). In addition, the components may be composed of a combination of the software and hardware components. The components may be reside on a computer-readable storage medium or may be distributed over a plurality of computers.

According to an exemplary embodiment of the present invention, an optimal reference frame can be selected when an input video stream is transcoded into a different format having a different GOP structure from that of the input video stream. Therefore, relatively high image quality or low bit rate can be achieved using limited computation power.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation.

What is claimed is:

1. A transcoder which transcodes an input video stream into an output video stream, the transcoder comprising:
a reconstruction unit which reconstructs transform coefficients and a video frame from the input video stream;
a selection unit which selects one of a first frame, which is referred to by the video frame, and a second frame, which is located at a different position from the first frame, based on sizes of the transform coefficients; and
an encoding unit which encodes the reconstructed video frame by referring to the selected frame.

2. The transcoder of claim 1, wherein the second frame is located immediately before the video frame.

3. The transcoder of claim 1, wherein the input video stream is a Motion Picture Experts Group (MPEG) standard video stream, and the output video stream is an H.264 standard video stream.

4. The transcoder of claim 1, wherein the selection unit selects the first frame as a reference frame for a block if a sum of absolute values of the transform coefficients for the block does not exceed a predetermined threshold value, and selects the second frame as the reference frame for the block if the sum of the absolute values of the transform coefficients for the block exceeds the predetermined threshold value.

5. The transcoder of claim 4, wherein the threshold value is obtained by dividing a sum of absolute values of transform coefficients included in a single frame by the number of blocks.

6. The transcoder of claim 4, wherein the threshold value is obtained by dividing a sum of absolute values of transform coefficients included in currently processed blocks among transform coefficients included in a single frame by the number of the currently processed blocks.

7. The transcoder of claim 4, wherein the threshold value is obtained by multiplying a value, which is obtained by dividing a sum of absolute values of transform coefficients included in a single frame by the number of blocks, by a predetermined variable coefficient, and the variable coefficient is determined by the number of blocks remaining to be processed in the single frame and a remaining time before a time limit.

8. The transcoder of claim 7, wherein the variable coefficient is obtained by dividing a value, which is obtained by dividing the number of the remaining blocks by the number of the blocks included in the single frame, by a value, which is obtained by multiplying the remaining time by a frame rate.

9. The transcoder of claim 1, wherein the encoding unit uses a motion vector of the input video stream if the selected frame is the first frame, and estimates a motion vector by referring to the second frame if the selected frame is the second frame.

10. The transcoder of claim 1, wherein the reconstruction unit comprises:
an entropy decoder which decodes the input video stream, and reconstructs quantization coefficients and motion vectors;
a dequantization unit which dequantizes the quantization coefficients to obtain the transform coefficients;
an inverse transform unit which inversely transforms the transform coefficients; and
an inverse prediction unit which performs motion compensation on a reference frame using the motion vectors to generate a predictive frame, and generates the reconstructed video frame by adding the predictive frame to the result of the inverse transform.

11. The transcoder of claim 1, wherein the encoding unit comprises:
a prediction unit which obtains motion vectors allocated to blocks of the reconstructed video frame using one of the first and the second frames as a reference frame, performs motion compensation on the reference frame using the motion vectors to generate a predictive frame, and generates a residual by subtracting the predictive frame from the reconstructed video frame;
a transform unit which performs a spatial transform on the residual to obtain the transform coefficients;
a quantization unit which quantizes the transform coefficients to generate quantization coefficients; and
an entropy encoder which encodes the quantization coefficients and the motion vectors to generate the output video stream.

12. A method of transcoding an input video stream into an output video stream, the method comprising:
reconstructing transform coefficients and a video frame from the input video stream;
selecting one of a first frame, which is referred to by the video frame, and a second frame, which is located at a different position from the first frame, based on sizes of the transform coefficients; and
encoding the reconstructed video frame by referring to the selected frame.

13. The method of claim 12, wherein the second frame is located immediately before the video frame.

14. The method of claim 12, wherein the input video stream is a Motion Picture Experts Group (MPEG) standard video stream, and the output video stream is an H.264 standard video stream.

15. The method of claim 12, wherein the selecting one of the first and the second frame comprises:
selecting the first frame as a reference frame for a block if a sum of absolute values of the transform coefficients for the block does not exceed a predetermined threshold value; and
selecting the second frame as the reference frame for the block if the sum of the absolute values of the transform coefficients for the block exceeds the predetermined threshold value.

16. The method of claim 15, wherein the threshold value is obtained by dividing a sum of absolute values of transform coefficients included in a single frame by the number of blocks.

17. The method of claim 15, wherein the threshold value is obtained by dividing a sum of absolute values of transform coefficients included in currently processed blocks among transform coefficients included in a single frame by the number of the currently processed blocks.

18. The method of claim 15, wherein the threshold value is obtained by multiplying a value, which is obtained by dividing a sum of * absolute values of transform coefficients included in a single frame by the number of blocks, by a predetermined variable coefficient, and the variable coefficient is determined by the number of blocks remaining to be processed in the single frame and a remaining time before a time limit.

19. The method of claim 18, wherein the variable coefficient is obtained by dividing a value, which is obtained by dividing the number of the remaining blocks by the number of the blocks included in the single frame, by a value, which is obtained by multiplying the remaining time by a frame rate.

20. The method of claim 12, wherein the encoding the reconstructed video frame comprises using a motion vector of the input video stream if the selected frame is the first frame, and estimating a motion vector by referring to the second frame if the selected frame is the second frame.
